(19) United States
(12) Patent Application Publication
(10) Pub. No.: US 2006/0195907 A1
(43) Pub. Date: Aug. 31, 2006

(54) Data processing device

(75) Inventors: Eckhard Delfs, Nurnberg (DE); Uwe Hildebrand, Erlangen (DE); David Jennings, Munich (DE); Michael Goedecke, Munich (DE)

Correspondence Address: DICKSTEIN SHAPIRO MORIN & OSHINSKY LLP., 1177 AVENUE OF THE AMERICAS 6TH AVENUE, NEW YORK, NY, 10036-1400, US

(73) Assignee: Infineon Technologies AG, Munich (DE)

(21) Appl. No.: 11/317,640

(22) Filed: Dec. 23, 2005

(30) Foreign Application Priority Data
Dec. 23, 2004 (DE) 10 2004 062 203.5

(51) Int. Cl. H04N 7/16; H04L 9/00; H04L 9/32; G06F 17/30; G06F 7/04; G06K 9/00; H03M 1/68; H04K 1/00

(52) U.S. Cl. 726/26; 713/176; 713/181

(57) ABSTRACT

A data processing device having data input unit for inputting data, a first processor, and a second processor. The first processor is set up for receiving and processing data which are input into the data input unit in a first data input mode, and the second processor is set up for receiving and processing data which are input into the data input unit in a second, security-related data input mode.

### CROSS-REFERENCE TO RELATED APPLICATION

This application claims priority to German Patent Application Serial No. 10 2004 062 203.5-53, which was filed on Dec. 23, 2004, and is incorporated herein by reference in its entirety.

### FIELD OF THE INVENTION

The invention relates to a data processing device, a telecommunication terminal and a method for processing data by means of a data processing device.

### BACKGROUND OF THE INVENTION

Security aspects, especially in the context of data transmission and data processing, generally in the context of data communication between two or more telecommunication terminals are gaining ever increasing importance both in landline network applications and in mobile applications.

It is of continuously increasing importance for users of a telecommunication system to protect their personal data without endangering their private sphere and the privacy of the personal data. In the context of electronic business traffic it is also important to reliably protect data and company asset components and relevant confidential information and, in particular, to be able to make a remote access very secure and to perform electronic business transactions in a secure manner.

Many attacks on computers or, respectively, the communication between computers, are based on or exploit weaknesses which, in particular, are inherent in so-called open operating systems, in particular the possibility in an open operating system to execute downloaded computer programs (software) on a respective computer on which the open operating system is installed. In this connection, particularly devices having such a computer which provide a radio interface and have an open operating system installed such as, for example, a Linux operating system, a UNIX operating system, a Symbian operating system, a Windows operating system or a Java platform, are at risk.

Since malicious computer programs, i.e. computer programs which cause damage (also-called damaging computer programs in the text which follows) such as, for example, computer viruses, computer worms or Trojan Horses have the potential of very rapidly spreading in a telecommunication network, it is of considerable significance to take suitable countermeasures against such threats.

In many application computer programs in which financial electronic transactions are provided between one or more users, it is common to ask a user for his authentication data such as, for example, a so-called PIN (personal identification number) code, or, in other words, a sequence of digits unambiguously identifying a user. A typical example of this is a mobile radio telecommunication terminal, for example a GSM mobile radio telephone or a UMTS mobile radio telephone in which the user enters a PIN code into the telecommunication terminal and in which the code input is compared with a corresponding value stored on a smart card (called SIM (subscriber identify module) in this case) and the user only obtains access to the functions of the mobile radio telecommunication terminal when the PIN code input corresponds to the stored code. In other application computer programs, it may be required to provide a so-called WIM (wireless identity module) in order to perform cryptographic operations by using private cryptographic keys.

As soon as a security-related computer program is executed on a processor or, in other words, on a computer, it is of great importance to ensure that no damaging computer program is executed on the platform, i.e. by the processor, which, for example, monitors data as part of the authentication procedure, generally as part of a security service provided. If this cannot be guaranteed, the monitored authentication data can be used by means of the damaging computer program during actually unwanted and unauthorized electronic financial transactions without the user, who is actually the only one authorized for such transactions by using the authentication data, obtaining knowledge of this.

In general, the problem described above can be formulated in the following manner:

How is it possible to achieve a secure authentication procedure in a system having a number of processors, where an open operating system is installed in at least one of the processors.

According to the prior art, different approaches to this are known.

On the one hand, a strict software installation security policy is provided for safeguarding the authentication, which reduces the probability of downloading damaging computer programs. This solution is usually based on utilizing so-called computer program certificates. Only correctly digitally signed computer programs (application computer programs) may be installed on the system and executed by the respective processor. This means that the system must be capable of verifying the digital signature via the respective computer program and checking the validity of the software certificate belonging to the computer program. The disadvantageous factor in this procedure is, in particular, the complexity of the security model used. In the certification process, a large number of different entities are involved which are not recognizable by the user. This can finally lead to the user being overtaxed with regard to the decision whether he trusts a respective software certificate, and thus a respective computer program, or not.

According to another approach, so-called antivirus software is used for protecting a computer against damaging computer programs, i.e., computer programs are used which recognize damaging computer programs and provide suitable countermeasures for combating the damaging computer program. In this concept, it is attempted to recognize the damaging computer programs which have already been downloaded to the system and to delete these again. This approach has the disadvantage, in particular, that only known risks, and thus only known damaging computer programs, can be countered. In the case of damaging computer programs not yet known to the antivirus computer program, the system on which the antivirus computer program is installed is unprotected against the hazard originating from the damaging computer program until the antivirus computer program has been correspondingly updated, in which update, for example, the new signatures of the damaging computer program are contained and thus recognition of this damaging computer program is made possible and then corresponding countermeasures can be taken.

In summary, according to the two approaches described above, it is not easily possible to guarantee that software downloaded to a computer will not compromise the computer system security.

From Tom R. Halfhill, ARM Dons Armor Microprocessor Report, Aug. 25, 2003, a security expansion called “trust zone” for the ARMV6 architecture of a microprocessor by ARM is known. It is described both there and in EP 1 329 787 A2, that for a single processor, this processor changes from a non-security-related operating mode into a security operating mode where in the security operating mode data, for example passwords, can be input, processed and displayed in a secure manner. According to Tom R. Halfhill, ARM Dons Armor Microprocessor Report, Aug. 25, 2003 and EP 1 329 787 A2, a multiplicity of commands are necessary for changing into the security operating mode or to leave this mode. This leads to restrictions with regard to the data processing speed of the respective computer system. Furthermore, these approaches require the provision of special countermeasures, for example the deactivation of insecure interrupts in the microprocessor, so that the security operating mode can not be left during the inputting or processing of the security-related data. For inputting passwords or other security-related data, it is necessary to guarantee that an application computer program can recognize the keys pressed, or access these, or can manipulate the display of the data input in order to mislead the user into inputting his password as is the case with Trojan Horse. For this reason, it is necessary that a data input unit and a data display unit in the security operating mode can be operated completely in the security operating mode for guaranteeing the secure data input or data output, respectively. Mixing non-secure data and security-related data on the same display unit, particularly on the same screen, is not possible according to Tom R. Halfhill, ARM Dons Armor Microprocessor Report, Aug. 25, 2003 and EP 1 329 787 A2. Thus, when inputting the security-related data into a computer system, it is only possible to a limited extent to convey to the user a sense of “look and feel” for the application computer program in the context of the display of the data input. Furthermore, according to these approaches, it is only possible with great difficulty and with great technical complexity to develop a suitable interrupt handling for the microprocessor so that the performance of real-time-critical tasks is not blocked, for example, due to a data input by a user. For this reason, it is not sufficient merely to provide a security operating mode, rather it is necessary to improve the capabilities of the peripheral devices for inputting and for outputting data in a computer system.

For safeguarding a personal computer whilst maintaining openness and flexibility of one of the personal computers, the “Trusted Computing Group” (TCG) has been created. The Trusted Computing Group is focused on the specification of important areas of an overall security solution, especially a hardware computer chip called “Trusted Platform Module” (TPM) as described in TPM Main Part 1 Design Principals, Specification Version 1.2, Revision 62, Oct. 2, 2003. The Trusted Platform Module is a hardware device by means of which a location which is cryptographically secure is provided for storing information and by means of which, furthermore, a set of cryptographic operations is provided which are performed in a secured environment and by means of which, furthermore, integrity metrics are stored and reported. A Trusted Platform Module is only part of the overall security solution for a computer system. Current trusted keyboards and trusted graphics display units and processors with improved security features and corresponding chip sets do not lie within its domain. Furthermore, it must be noted that the Trusted Computing Group has focused on the specification of a Trusted Platform Module for a personal computer. Recently, however, the Trusted Computer Group has begun to define Trusted Platform Modules also for mobile telecommunication terminals, for handheld computers and server computers as can be seen, for example, from R. Meinschein, Trusted Computing Group Helping Intel Secure the PC, Technology Intel Magazine, January 2004-12-01.

From EP 1 329 787 A2, a display of a security operating mode is also known by which the user of the computer system is informed that the computer is in a security operating mode. The security display there is a light-emitting diode which, however, may possibly be overlooked by a user.

EP 1 056 014 A1 describes a system for providing a trusted user interface. According to this system, a trusted data display processor is provided, the trusted processor and a trusted memory being physically and functionally separated from the processor and the memory of the actual computer system.

Furthermore, a computer-supported games console is known from US 2002/0068627 A1, in which a security controller executes a games computer program and conveys a stream of data display commands to a data display engine which, in turn, then generates the video display of the game by means of a video output signal. The video output signal is transmitted to a video multiplexer within the security controller. The video multiplexer selects between the games video output and an audit operating mode video output under the control of an output selection function. The output selection function is controlled by the security controller. According to US 2002/0068627 A1, however, it is not possible to divide the video output into different areas as part of the data display, i.e. of the video output to a user, where the divided data streams can be controlled by different sources.

WO 02/100016 A1 describes a device for the secure input of data by means of a keyboard by using a graphic user interface, the user inputting a security code by moving a cursor and characters or symbols being selected on a graphic user interface display by means of a computer mouse, a touch-sensitive screen or other devices suitable for this purpose. After each new selection, the symbols and characters of the graphic user interface are rearranged on the screens so that the input of the security code cannot be reconstructed even in the case where the cursor movement on the screen is detected during input of the security code by a user.

In the system described in WO 99/61989 A1, a trusted data input unit is coupled to a co-processor and a non-trusted keyboard has a security information display for indicating a security operating mode.

US 2003/110402 A1 describes a method for inputting a password in a mobile radio telecommunication terminal. In this method, certain characters are sought in a password character table which correspond to a counted number of indications of a specific character key.

U.S. Pat. No. 5,920,730 describes a computer keyboard arrangement with a chip card interface and with a keyboard and chip card controller, the signals generated by means of the keyboard being forwarded by the controller either to a personal computer or to the chip card interface.

### SUMMARY OF THE INVENTION

A data processing device having a data input unit for inputting data into the data processing device, a first processor set up such that, in a first data input mode, it receives and processes the data input into the data input unit, the first processor having control over the data input unit in the first data input mode, and a second processor set up such that, in a second, security-related data input mode, it receives and processes the data input into the data input unit, the second processor having control over the data input unit in the second data input mode.

### BRIEF DESCRIPTION OF THE DRAWINGS

Exemplary embodiments of the invention are shown in the figures and will be explained in greater detail in the text which follows.

FIG. 1 shows a block diagram in which the architecture of a data processing device according to an exemplary embodiment of the invention is shown;

FIG. 2 shows a sketch of a mobile radio telecommunication terminal according to an exemplary embodiment of the invention;

FIG. 3 shows a sketch of a mobile radio telecommunication terminal according to a further exemplary embodiment of the invention;

FIG. 4 shows a sketch of a data processing device according to yet another exemplary embodiment of the invention;

FIG. 5 shows a block diagram of a further data processing device according to another exemplary embodiment of the invention;

FIG. 6 shows a message flow chart in which a variant of the switching between two data input modes is shown;

FIG. 7 shows a flow chart in which individual method steps for providing a secure input in the second data input mode according to an exemplary embodiment of the invention is shown; and

FIG. 8 shows a block diagram in which an alternative embodiment of a data processing device is shown.

If necessary, the same or identical elements are provided with identical reference symbols in the figures.

### DETAILED DESCRIPTION OF PREFERRED EMBODIMENTS OF THE INVENTION

The invention is based on an object of creating a secure input of data in a data processing device.

The object is achieved by a data processing device, a telecommunication terminal and by a method for processing data by means of a data processing device.

The embodiments of the invention as described relate both to the data processing device and to the telecommunication terminal and the method for processing data by means of a data processing device.

A data processing device comprises a data input unit for inputting data into the data processing device. Furthermore, a first processor and a second processor are provided in the data processing device. The first processor is set up in such a manner that, in a first, preferably non-security-related data input mode, it receives and processes the data input into the data input unit. The second processor is set up in such a manner that, in a second, security-related data input mode, it receives and processes the data input into the data input unit.

A telecommunication terminal comprises a data processing device described above.

Furthermore, in a method for processing data, data are input into the data processing device by means of a data input unit. The data input into the data input unit are received and processed by a first processor in a first, preferably non-security-related data input mode. The data input into the data input unit are received and processed by a second processor in a second, security-related data input mode.

In contrast to the procedures according to the prior art as described above, the invention does not have the aim of recognizing, and removing from a computer system, damaging computer programs or program components which can monitor confidential data input in an open operating system environment.

In contrast to the prior art, an aspect of the invention is illustratively based on the inputting of confidential, and thus sensitive data into the system, i.e. into the data processing system being controlled by means of a trusted entity within the data processing device, preferably by means of the second processor. Since it is exclusively trusted computer programs which run on the second processor, which is why the second processor is also-called “trusted core” processor, the implementation according to the invention guarantees that only trusted computer programs, i.e. only trusted software, which is used for dealing with and processing confidential data, can be executed on the second processor.

Compared with the general use of software certificates, the approach according to the invention is particularly characterized by the fact that it has been recognized that only a relatively small part of computer programs is security-related in such a manner that only this small part needs to be protected with corresponding certificates or other security measures, for example by the second processor having stored a small and limited number of computer programs in a memory only accessible to it, and executing these, where these computer programs implement and thus provide security-related services which will be explained in more detail in the text which follows. This ensures that only software with proven and reliable data integrity is executed by the second processor.

An aspect of the invention can illustratively be seen in that a trusted mechanism for secure input of security-related, i.e. confidential data such as, for example, of a PIN code or of a password etc. can be provided to a user of the system, this mechanism being protected against monitoring in an open operating system, i.e. in an open computer environment. Means are provided which define and provide an operation of the data processing device in a secure operating mode (second, security-related data input mode) and an unsecured operating mode (first data input mode).

The data processing device preferably has the following components:
a data input unit, for example a keyboard which, in the normal operating mode (first data input mode) is allocated to the first processor, which is preferably set up as application processor, and which is temporarily allocated to the second processor (trusted core) within the data processing device, i.e. is allocated by the latter.
As an alternative, in the normal operating mode, the data input unit can forward the symbol input (for example the data symbol allocated to the key pressed) directly to the application processor. Once the second processor is activated for receiving a data input according to a request, the data input unit, following an input of data, will not directly forward these to the application processor as in the normal operating mode but transmits a predetermined adjustable character/data symbol, preferably for each key pressed, i.e. for each data symbol input, for example an “*” symbol instead of the data symbol or character actually input, to the application processor which outputs it, for example in a PIN input field in an input mask which is provided by the application processor and/or the second processor in a graphical user interface. In this case, it is preferably provided that control keys, which can be predetermined for the application processor, for example a deletion key, are still transferred in their functionality. The data input, i.e. more accurately each character or data symbol input, are accumulated, i.e. collected, in a memory or in a part of a memory, where this memory or the part of the memory can only be written to or read by the second processor, i.e. it is only the second processor which has access to this memory or part of the memory. Once the input of the confidential data has been concluded, the data sequence input is processed by the second processor, for example compared with a corresponding value or with a plurality of corresponding values in a comparison table, where the value or values can be stored, for example, on a smart card or in a flash memory in plain text or even encrypted. If the comparison data are stored in encrypted form, the second processor has access to a corresponding cryptographic key and decryption process suitable for decryption. The normal interrupt mode of the microprocessor is deactivated for these program steps described above, thus ensuring that only the security service provided for the data input of confidential data cannot be interrupted and thus the data input is illustratively “encapsulated”. Generally, the security service provided in each case is thus “encapsulated”.
The second processor preferably displays on a data display unit that the data processing unit is in the second data input mode, for example optically (preferably by means of a light-emitting diode, by background illumination of the keys etc. or by means of a symbol (seal) displayed on the data display unit) or by means of the representation of audio information (preferably of an alarm signal or by means of a sequence of tones unambiguously identifying the second data input mode), where it is ensured that the data display unit (graphical or for outputting audio information) can only be controlled by the second processor and not by the first processor, i.e. not by the application processor. This provides the user in a reliable and simple manner with the information that the data processing device is in the second data input mode and the user can thus also input trusted or confidential data without second thoughts.

The data input unit can be one of the following data input units:
a keyboard;
a data communication interface;
a touchpad;
a touch screen;
a computer mouse; or
a microphone including a unit for voice recognition, for example a unit for speaker-dependent voice recognition, and/or a unit for speaker-independent voice recognition.

This means that the invention is suitable for any type of data input, either directly at the data processing device or via a telecommunication network (landline communication network or mobile radio telecommunication network). As soon as the input of security-related data has to be protected, the data processing device, for the purpose of receiving and processing the confidential data input, switches to the second processor which is correspondingly set up and protected for trusted processing of the data input.

The first processor is preferably an application processor which is set up for executing application computer programs in an open operating system, an open operating system, in this sense, being an operating system which preferably has at least one communication interface external to the operating system and is thus vulnerable to external attacks, for example by means of a computer virus, by means of a Trojan Horse, by means of a computer worm or generally by means of damaging computer programs.

Examples of an open operating system are the Windows operating system, the Linux operating system, the Unix operating system, the Symbian operating system or a Java platform.

According to another embodiment of the invention, it is provided that the second processor is set up as so-called trusted core processor. The second processor is thus illustratively set up in such a manner that it can only execute one or more trusted computer programs. This can be implemented, for example, by either a certain set of a predetermined number of procedures implementing security in the form of computer programs being stored by the manufacturer in a memory only accessible to the second processor or by software certificates, which are applied to the security services to be implemented in each case, i.e. the software certificates associated with the respective computer programs implementing security services, being checked by the second processor before they are executed in each case and the program only being executed on the second processor when the software certificates have been successfully checked.

A trusted computer program is preferably an integrity-protected, preferably cryptographically integrity-protected computer program which, in particular, implements at least one security-related service, preferably at least one cryptographic security service.

The second processor is, particularly when the data processing device is constructed as telecommunication terminal, especially as mobile telecommunication terminal, a digital signal processor which is set up for performing one or more respective security services.

The second processor is preferably a microcontroller, for example in the case where a number of microcontrollers and possibly also an additional digital signal processor are provided in the data processing device, that is to say, for example, a microcontroller for applications, a microcontroller for trusted services, for modem services and a digital signal processor for real-time-critical services, particularly in the context of digital signal processing.

It must be pointed out in this connection that it should be ensured that the operations of the trusted second processor must not be disturbed by the untrusted first processor. This can be achieved, for example, by dedicated main memories for the two processors or when a common main memory is used by using a memory controller which is controlled by the “trusted” second processor and can issue explicit access rights for certain address areas.

The cryptographic security service is preferably provided by using at least one cryptographic key, for example by using at least one private cryptographic key and/or at least one public cryptographic key.

In other words, this means that the cryptographic security service can be implemented both by using a symmetric key mechanism and by an asymmetric key mechanism in the respective security service.

At least one of the following security services is provided as cryptographic security service:
digital signature; and/or
digital seal; and/or
authentication; and/or
encryption of data; and/or
admission control; and/or
access control; and/or
prevention of traffic analyses during a data communication; and/or
hash process.

In principle, any cryptographic security service which, in particular, involves an input of security-related, and thus confidential information by a user into the data processing device by means of the data input unit, can be implemented as computer program which is performed by the second processor.

In this manner, a very flexible extendibility of the data processing device with regard to its cryptographic usability whilst guaranteeing the protection of the user data input is implemented, particularly due to the programmability of the second processor.

According to another embodiment of the invention, a data display unit is provided for displaying at least a part of the data input to a user.

In this manner, in particular, an operating “look and feel” has been achieved for the user for inputs of security-related data or non-security-related data into the data processing device.

The data processing device is preferably set up in such a manner that in the second data input mode, the second processor receives the data input and transmits data, which are different from the data input, preferably with the same number of data symbols, to the first processor and/or the data display unit. In this manner, the usability and, in particular, the operating “look and feel” is further improved for the user since he is immediately shown an acknowledgement with regard to the input made for each input made, for example for each key pressed even if he is not shown which input he has actually performed, for example which key he has actually pressed.

The data processing device is preferably set up in such a manner that the data transmitted from the second processor to the first processor and/or the data display unit are a sequence of predetermined data symbols, particularly a sequence of a predetermined data symbol, the number of data symbols being identical to the number of data symbols of the data input. Furthermore, the second processor can be set up in such a manner that it transmits a security mode display information item in the first processor and/or the data display unit in the second data input mode. The result is that the user is reliably provided in a simple manner with the information that he can input confidential information by means of the data input unit into the data processing device without risk.

The security mode display information is preferably visual information and/or audio information.

Furthermore, a process communication unit can be provided for performing the communication between the first processor and the second processor during the transfer of control of the data input unit from the first processor to the second processor or from the second processor to the first processor. In other words, this means that according to this embodiment of the invention, the transfer of the control of the data input unit or of the receiving and processing of the data input takes place by means of an inter-processor communication between the two processors.

This implementation has the advantage, in particular, that due to the use of mechanisms, known per se, for communication between two processors, the transfer of rights can take place in a simple and inexpensive manner in the context of the secure data input.

Furthermore, a data input unit driver unit can be provided which is preferably set up as a computer program and which is set up in such a manner that
the data input in the first data input mode are transmitted to the first processor; and
the data input in the second data input mode are transmitted to the second processor.

Thus, according to this embodiment of the invention, the data input driver unit represents a type of switch in which it is decided whether the data input are of confidential type and thus to be supplied to the second processor or if the data input are not security-related, in which case the data are transmitted directly to the first processor, preferably the application processor.

The data input unit driver unit can be set up in such a manner that data, which are different from the data input in the second data input mode, are transmitted preferably with the same number of data symbols, to the first processor and/or the data display unit.

According to this embodiment of the invention, it is preferred that the data transmitted to the first processor and/or the data display unit are a sequence of predetermined data symbols, particularly a sequence, i.e. a plurality of an identical predetermined data symbol, the number of data symbols being equal to the number of data symbols of the data input.

According to another embodiment of the invention, the second processor is set up as chip card processor, in other words the second processor is implemented on a chip card which is brought into communication with the first processor and the data input unit by means of a chip card reader which is connected, for example, to a personal computer or also to a telecommunication device. In this manner, the processor provided on a chip card is used even for a conventional personal computer for guaranteeing the secure data input into, for example, the personal computer, using a chip card reader which is frequently provided these days, particularly in the context of a corresponding security architecture, achieving a secure data input.

In one embodiment of the invention it is provided, particularly for the case where the data processing device is set up as a telecommunication terminal, particularly as a mobile radio telecommunication terminal, that the processor provided in a SIM (subscriber identity module) is utilized as the second processor for implementing the security services provided in each case.

The invention is particularly suitable for use in the course of inputting a password or a PIN code, i.e. an authentication symbol sequence which is preferably only known to one user, or also for encrypting or digitally signing data, for example for encrypting or digitally signing an electronic message (electronic mail (e-mail)) by using cryptographic material which needs a user input in the form of a PIN code or of a password. The respective electronic message can be transmitted to a receiver by means of the telecommunication terminal, preferably an air interface, but it can also be only temporarily stored in a corresponding list in a computer system itself and interrogated again by the user or another user when required and, if necessary can be decrypted again there.

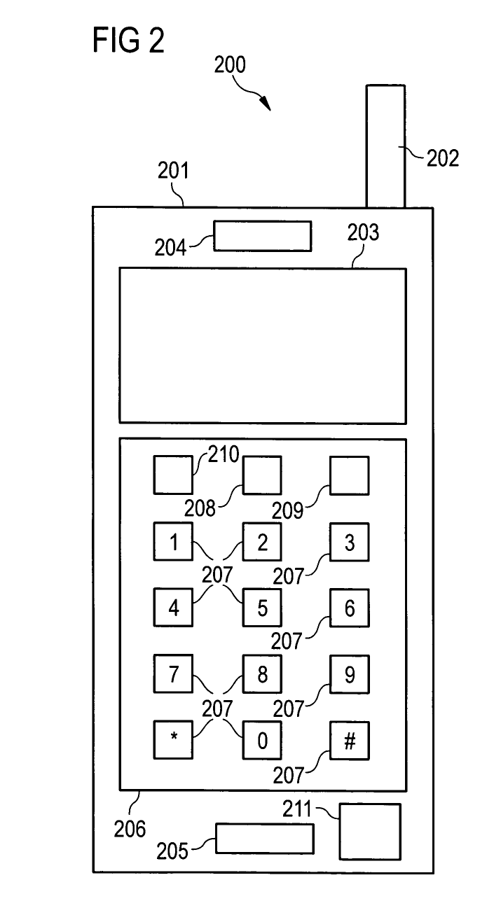

FIG. 2 shows a mobile radio telecommunication terminal 200 which is set up for communication according to a cell-based mobile radio standard, for example according to GSM, a 3GPP standard, for example UMTS, etc.

The mobile radio telecommunication terminal 200 comprises a housing 201 in which an antenna 202 is accommodated, and a display 203, a loudspeaker 204, a microphone 205 and, in a keypad 206, a multiplicity of keys, among these numerical keys or symbol keys 207 for inputting digits, symbols or letters in a manner known per se, and special function keys such as a communication set-up key 208 and a communication terminating key 209 for setting up and terminating a telecommunication link, for example. Furthermore, at least one special function key 210 is provided which can be allocated predeterminable special functions such as, for example, the calling up of an address book/telephone book stored in the mobile radio telecommunication terminal 200.

Furthermore, the mobile radio telecommunication terminal 200 contains a SIM (subscriber identity module) card 211 in which information unambiguously identifying a user, also-called user identifier, is stored.

As will be explained in greater detail in the text which follows, the mobile radio telecommunication terminal 200 comprises two processors (not shown), namely a first processor for executing application programs (also-called application processor in the text which follows) and a digital signal processor (DSP) for providing, in particular, the functions of the physical interface, i.e. the functionality of the radio signal transmission, for example for decoding mobile radio signals, etc. Furthermore, a memory, not shown, is provided, the two processors and the memory being coupled to one another by means of a computer bus.

In an alternative embodiment of the invention, the mobile radio telecommunication terminal 200 comprises a second processor set up as microcontroller. Furthermore, at least one additional microcontroller is provided in this embodiment, and possibly also an additional digital signal processor. In one microcontroller, the application computer programs are executed, in another microcontroller, the trusted services and possibly also modem services are executed, i.e. provided. Furthermore, a digital signal processor for real-time-critical services, particularly in the context of digital signal processing, is provided.

If a user wants to register with the mobile radio telecommunication network after switching on the mobile radio telecommunication terminal 200, the user is asked by the mobile radio telecommunication terminal 200 to input a personal identification number (PIN) by means of the keys 207. In this case, the security-related function or procedure, described in the text which follows, is the inputting of a PIN into the mobile radio telecommunication terminal 200.

The personal identification number input is compared with the user identity (UID) stored in the SIM card 211 and the subscriber is accepted as authorized subscriber by the mobile radio telecommunication network and thus registered as authorized subscriber with the mobile radio telecommunication network, when the number input corresponds to the user identity stored in the SIM card 211.

The switching, according to the invention, between overall control via the keys 207, 208, 209, 210, particularly the digit keys in the keypad 206 during the registration procedure will be explained in greater detail in the text which follows.

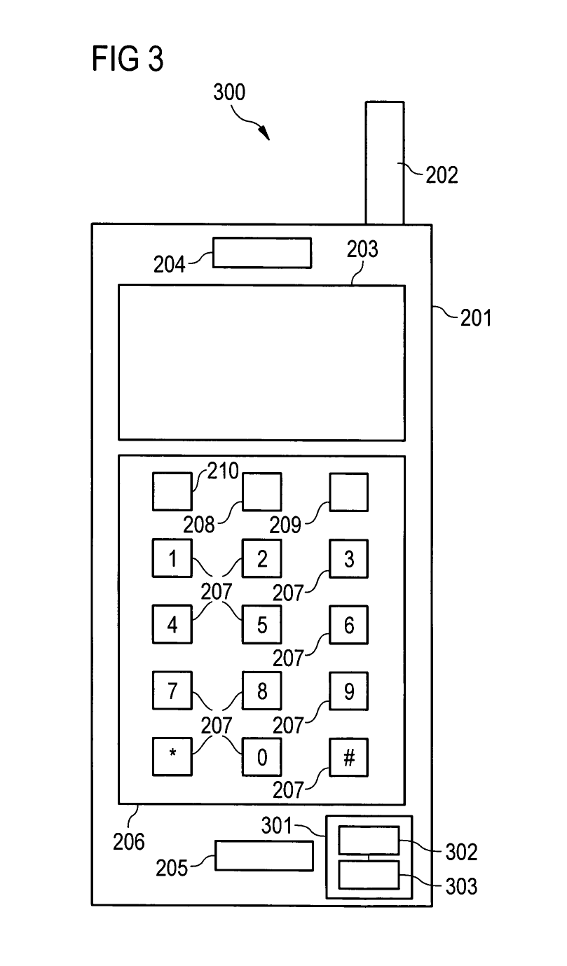

FIG. 3 describes a mobile radio telecommunication terminal 300 according to a second exemplary embodiment of the invention.

Structurally, the mobile radio telecommunication terminal 300 is constructed in the same manner as the mobile radio telecommunication terminal 200 according to the first exemplary embodiment of the invention, the difference being that the digital signal processor can be optionally omitted and the second processor, provided according to the invention for the security-related data input of the personal identification number is contained as microprocessor on the SIM card 303 which comprises a microprocessor 302 and a non-volatile memory 303, and not only a non-volatile memory for storing the user identity like the SIM card 211 according to the first exemplary embodiment.

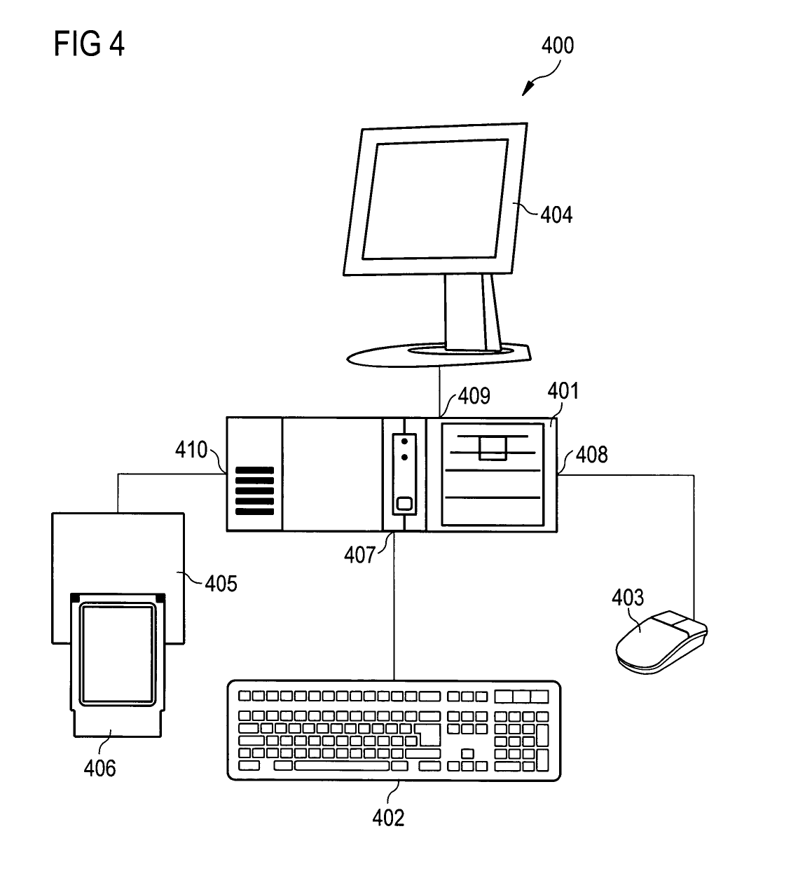

According to a third application scenario, a block diagram 400 in FIG. 4 shows a personal computer 401 which contains an application processor (not shown), and one or more memory elements, the processor and the memories being coupled to one another via a computer bus and to external communication interfaces and via these to a plurality of peripheral devices, for example a keyboard 402, a computer mouse 403, a screen 404 as data display unit and to a chip card reader 405 by means of which a chip card 406, and thus the information stored in the chip card, can be read and transmitted to the personal computer 401.

In the text which follows, different scenarios are explained by means of the arrangement 400 shown in FIG. 4:
According to a first alternative, the first processor is contained in the personal computer 401 and the second processor is contained in the chip card reader 405 which provide the services described in the text which follows.
According to an alternative embodiment, the chip card 406 comprises its own microprocessor which is used as second processor in the method described in the text which follows.
According to another embodiment, it is provided that two processors are contained in the personal computer 401.
According to yet another embodiment, it is provided that a processor is provided in the data display unit 404 and is used as second processor during the protected data input of confidential data.

It must be pointed out that, depending on requirement, one or more of the data input units shown in FIG. 4 can be used for inputting security-related data into the personal computer 401 via a respective peripheral interface 407, 408, 409, 410.

It must be pointed out that data can be input by means of the keyboard 402, by means of the computer mouse 403, by means of the data device 404 possibly constructed as touch-sensitive screen, or by means of the chip card reader 405.

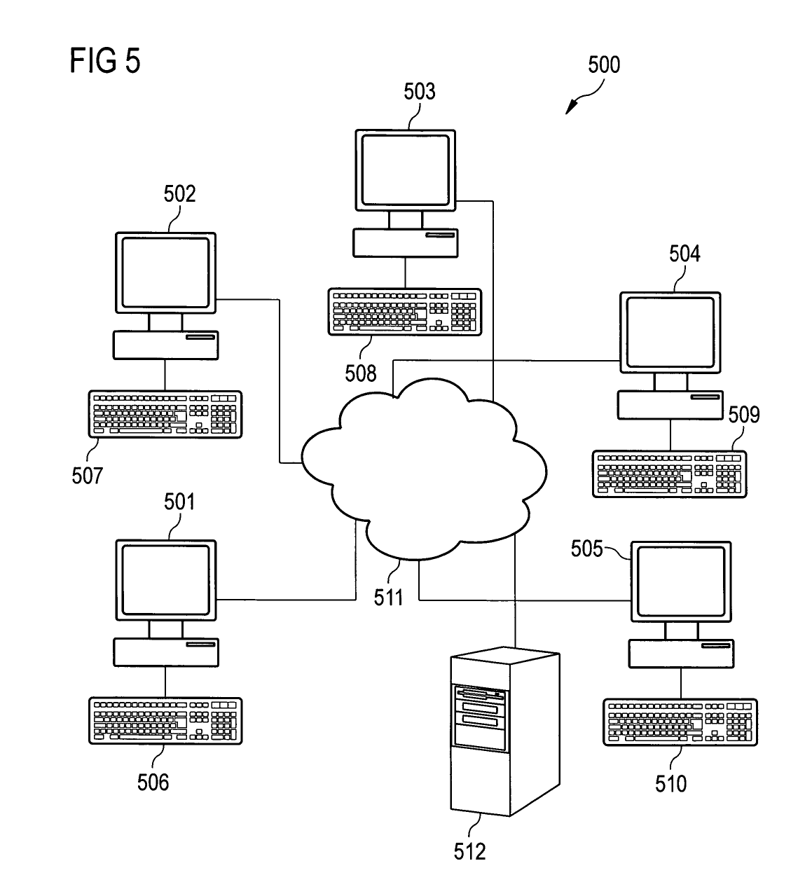

FIG. 5 shows another data processing device arrangement 500 according to another exemplary embodiment of the invention.

According to this arrangement 500, a multiplicity of client computers 501, 502, 503, 504, 505 are provided which in each. case comprise a keyboard 506, 507, 508, 509, 510 and/or a computer mouse (not shown) as data input unit, the client computer 501, 502, 503, 504, 505 being coupled to a server computer 512 by means of a telecommunication network 511.

In this case, security-related data, particularly authentication data, are transmitted via the telecommunication network, preferably the internet/intranet 511 to the server computer 512, where they are used during the authentication of a client computer 501 to 505. In this case, the server computer 512 comprises two processors and the input unit is the input/output interface of the server computer 512 to the telecommunication network 511, since it is via this that a sequence of data symbols is supplied to the server computer 512.

The procedures described generally in the text which follows apply to all application scenarios described above and it is only required for two processors to be provided which can communicate with one another, or that optionally the data input can be supplied, if necessary, to one of the two processors provided.

As described above, the respective data input unit can be a keyboard, a data communication interface or an input/output interface to a communication network or to another peripheral device of the data processing device, a touchpad, a touch screen, a computer mouse or a microphone, where voice signals spoken into the data processing device by means of the microphone are converted by means of a voice recognition unit into data symbols which represent the data input.

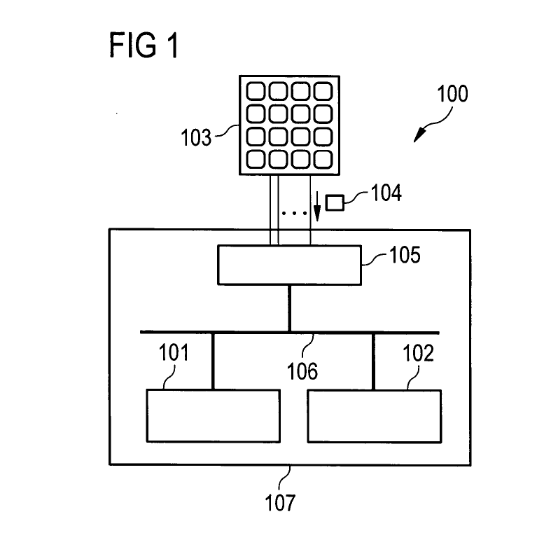

Thus, the system architecture 100 shown by way of example in FIG. 1 is used as a basis for all application scenarios described above and arrangements linked to these.

Most of the application computer programs which also have a user interface, for example the input/output interface for receiving and transmitting data from and to a peripheral device, respectively, are executed by an application processor 101 (first processor). In the application processor 101, an open operating system, preferably a Windows operating system or, as an alternative, a Linux operating system, a Unix operating system, a Symbian operating system or a Java platform is installed and executed.

Furthermore, a second processor 102 is provided which runs in a trusted mode. The second processor 102 is also-called trusted core processor and thus runs in a trusted, preferably cryptographically protected environment and is used in the following for providing security-related services, particularly cryptographic security services, alternatively or additionally for other services, for example for providing functions of the physical interface during a data transmission, particularly a mobile radio data transmission. In the case of an application where the data processing device is constructed as mobile radio telecommunication terminal (compare FIG. 1 and FIG. 2), this usually comprises two processors, namely the application processor and a digital signal processor (DSP).

In a first operating mode (normal operating mode), the keyboard 103, generally the data input unit, is allocated to the application processor 101 and is controlled by the latter. The application processor 101 is thus responsible for controlling and processing the data 104, input by means of a keyboard 106, generally an alternative data input unit described above, by means of a keyboard peripheral block 105 which is jointly arranged preferably with the application processor 101 and the second processor 102, coupled by means of a system bus 106, in a common integrated system controller circuit 107.

In the application scenarios described above, in which the second processor 102 is not provided jointly with the application processor 101 in an integrated circuit 107, the two processors 101, 102 are coupled to one another, for example by means of a cable or another type of communication link, for example a radio communication link.

If security-related data are to be input by the user into the data processing device 100, for example during an authentication of the user, the control is handed to the second processor 102 over the data input unit, preferably the keyboard 103, until the inputting of the confidential data is ended. This makes it possible to achieve that a confidential data input will not leave the trusted environment of the system 100.

In the embodiments in which the data processing device is integrated in a mobile radio telecommunication terminal, the processors are, for example, both ARM926 processors; as an alternative, the application processor is an ARM11 processor.

In the text which follows, different alternatives for implementing a security-related data input mode within the data processing device are represented.

According to a first preferred embodiment, an explicit handover of control over the data input unit, preferably the keyboard 103 from the application processor 101 to the trusted second processor 102 and from the latter back to the application processor 101 is provided.

In this case, the possession, i.e. illustratively the control over the data input unit, preferably the keyboard 103, is transferred from the application processor 101 to the second processor 102 and, respectively, back from the latter to the application processor 101 by means of explicit inter-processor communication.

This requires that both processors, i.e. both the application processor 101 and the second processor 102 in each case contain and can execute a computer program which enables them to determine which one is actually currently having control over the data input unit 103, and a computer program which performs the transfer or, in other words the hand-over of control over the data input unit 103 to the respective other processor 101 or, respectively, 102.

During the security-related data input mode, the trusted core processor (second processor) 102 for a limited period of time has control over the data input unit 103 by means of which the security-related, i.e. confidential data are input into the data processing device 100. During this time, the trusted core processor 102 preferably activates a secure input display by means of which a user is informed that the data processing device 100 is in the second, secure data input mode. Different options for implementing the display of the second, i.e. security-related data input mode will be explained in greater detail further below.

In this connection, it must be noted that, for a reliable display of the second data input mode to the user, it is desirable if the application processor 101 cannot control this display when this information is displayed to the user.

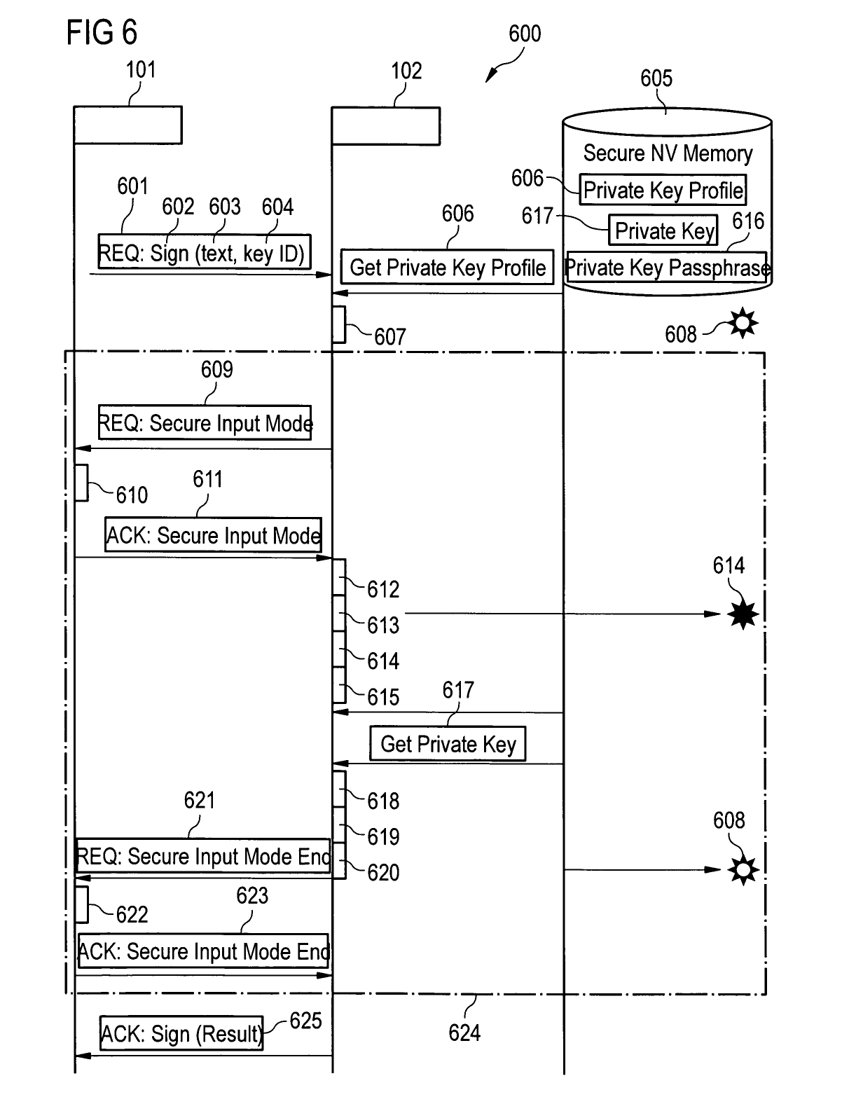

In an information flowchart 600 in FIG. 6, an example is shown in which a password is input into the data processing device as confidential data symbol sequence and is used for digitally signing a file.

In the sequence shown in the flowchart 600, an implicit activation of the second data input mode (secure input mode) into the trusted core processor 102 is triggered by the reception of an inquiry message for signing an electronic file.

As shown in FIG. 6, according to this example, the application processor 101 generates a signing request message 601 and transmits it to the second processor, i.e. the trusted core processor 102, preferably via the system bus 106. In the signing request message 601, the requested security service, namely the performance of a digital signature (sign) 602 over an electronic file is specified, and, as parameter of the requested service, the electronic file to be digitally signed (text) 603 and a key identification information (key ID) 604.

Following reception of the signing request message 601, the trusted core processor 102 requests a private key profile 606 from a non-volatile memory 605, only accessible to it, and verifies the signing request message 601 by using the private key profile 606 read out (step 607).

Up to this time, the data processing device 100 is still in the first data input mode, i.e. in an unsecure data input mode, in which the application processor 101 still has control over the data input unit 103.

This is indicated to the user on a screen by means of a first data input mode indication 608 identifying the first data input mode.

Following this, the data input mode of the data processing device 100 changes to the second, security-related data input mode.

In a subsequent step, the trusted core processor 102 sends a first mode change request message 609 to the application processor 101, requesting the change of the data input mode from the first data input mode to the second data input mode from the application processor 101 by means of the first mode change request message 609.

After receiving the first mode change request message 609, the application processor 101 releases its control over the data input unit 103, particularly over the keyboard 103 (step 610).

The trusted core processor 102 is informed about the release of the keyboard control by the application processor 101 by means of a first mode change acknowledgement message 611.

Following reception of the first mode change acknowledge message 611, the trusted core processor 102 takes over control over the data input unit 103, particularly over the keyboard 103 (step 612).

After that, the trusted core processor 102 activates the data input mode indication and sets it to a second data input mode indication 614 by means of which is specified that the data processing unit is in the second data input mode (step 613). This activation is performed exclusively under control of the trusted core processor 102, i.e. the application processor 101 has no access and no possibility of controlling the data input mode indications 608, 614.

Following this, the trusted core processor 102 collects the characters or data symbols successively input by the user, which represent the confidential data input (step 614). For example, the individual symbols of the requested password are successively temporarily stored in a non-volatile memory, for example in the non-volatile memory 605 of the trusted core processor 102.

The password in the non-volatile memory should be protected against an access by the “untrusted” first processor. For this process, the “trusted core”, i.e. the second processor, either has a dedicated reserved non-volatile memory. The password is preferably stored encrypted in the non-volatile memory and can only be decrypted by means of a key which is in the exclusive “possession” of the second processor, e.g. guaranteed by one or more special hardware chip(s). This means that only the second processor has access to the key for decrypting the password.

In an alternative embodiment or in addition to the above embodiment, it is provided, for increasing the processing efficiency, to perform the temporary storage of the password in a volatile memory. For this purpose, the volatile memory should be protected against manipulation of the “untrusted” first processor.

In other words, this means that it should be ensured that the operations of the trusted second processor cannot be disturbed by the (untrusted) first processor. This can be achieved, for example, by dedicated main memories of the two processors or, if a common main memory is used, by using a memory controller which is controlled by the “trusted” second processor and can issue explicit access rights for certain address areas.

In a subsequent step (step 615), the password read in is compared by the trusted core processor 102 with the private password 616 previously stored in the non-volatile memory 605.

If the password input matches the password 616 stored in the non-volatile memory 605 for the private key of the user, the trusted core processor 102 then reads the private key 617 of the user out of the non-volatile memory 605 and signs the text 603, specified in the request message 601, by using the private key of the user (step 618).

After that, the trusted core processor 102 again hands over control over the data input unit 103 (step 619) and deactivates the second data mode indication 614 by means of which the second data input mode is indicated, in such a manner that now the first data input mode for inputting non-confidential data is again indicated to the user by means of the data mode indication 608 (step 620).

After that, the trusted core processor 102 sends a second mode change request message 621 to the application processor 101 and by this means requests another change of the data input mode, but this time from the second, security-related data input mode to the first data input mode, i.e. the normal operating mode for inputting non-confidential data into the data processing device 100.

Following receipt of the second mode change request message 621, the application processor 101 then takes over control over the data input unit 103 (step 622).

The trusted core processor 102 is informed about the end of the repeated transfer of control over the data input unit 103 by the application processor 101 by means of a second mode change acknowledgement message 623, by which means the second input mode is ended (symbolized in FIG. 6 by means of the reference symbol 624).

After that, the trusted core processor 102 conveys to the application processor 101 the result of the requested security service, in this exemplary case the digital signature 625 via the electronic file 603 specified in the signature request message 601.

According to an alternative embodiment, it is provided that the data input unit, particularly the keyboard 103, for the application processor 101 is used transparently both by the application processor 101 and, if necessary, also by the trusted core processor 102.

In this embodiment, it is not known to the application processor 101 that the data input unit 103 is temporarily used by the trusted core processor 102 in the course of the second data input mode. In other words, the application processor 101 is not informed that a change of the input mode from the first data input mode into the second data input mode and conversely is taking place.

During the second data input mode, i.e. until the input of the confidential data is concluded, the following mechanism for processing and receiving each character or data symbol input which is input by means of the data input unit 103 into the data processing device is provided by means of an data input unit driver computer program, preferably a keyboard driver computer program which is implemented in the secure environment of the trusted core processor 102 and is executed by the trusted core processor 102:
1. The connection between the data input unit 103 and the application processor 101 is separated (“disconnect”).
2. In the second data input mode (secure input mode), a data symbol input is read in.
3. A predetermined symbol, preferably an “*” symbol, is written into a keyboard peripheral register provided in order to simulate the inputting of a data symbol for the application processor 101.
4. The connection between the data input unit 103 and the application processor 101 is set up again (“connect”).

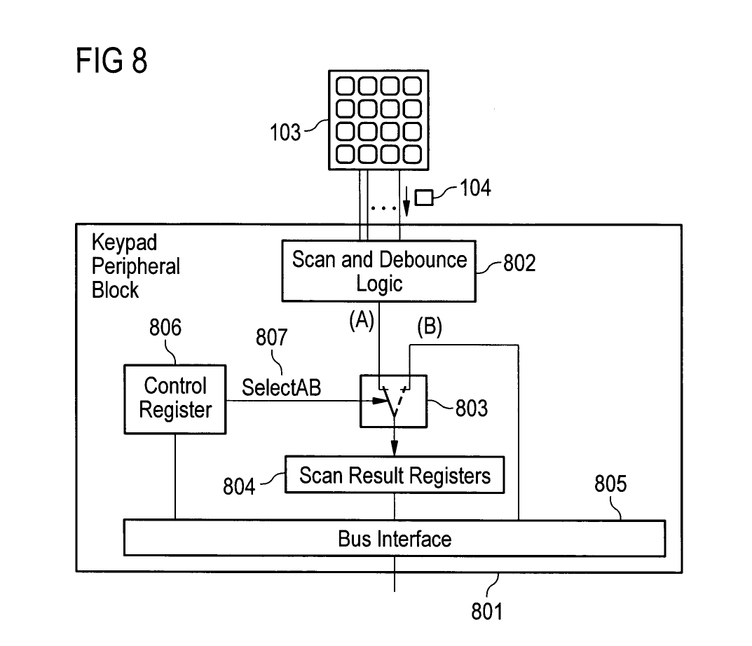

It must be noted that the data input unit peripheral block 801 of the arrangement 800, shown in FIG. 8, is preferably used in step 3.

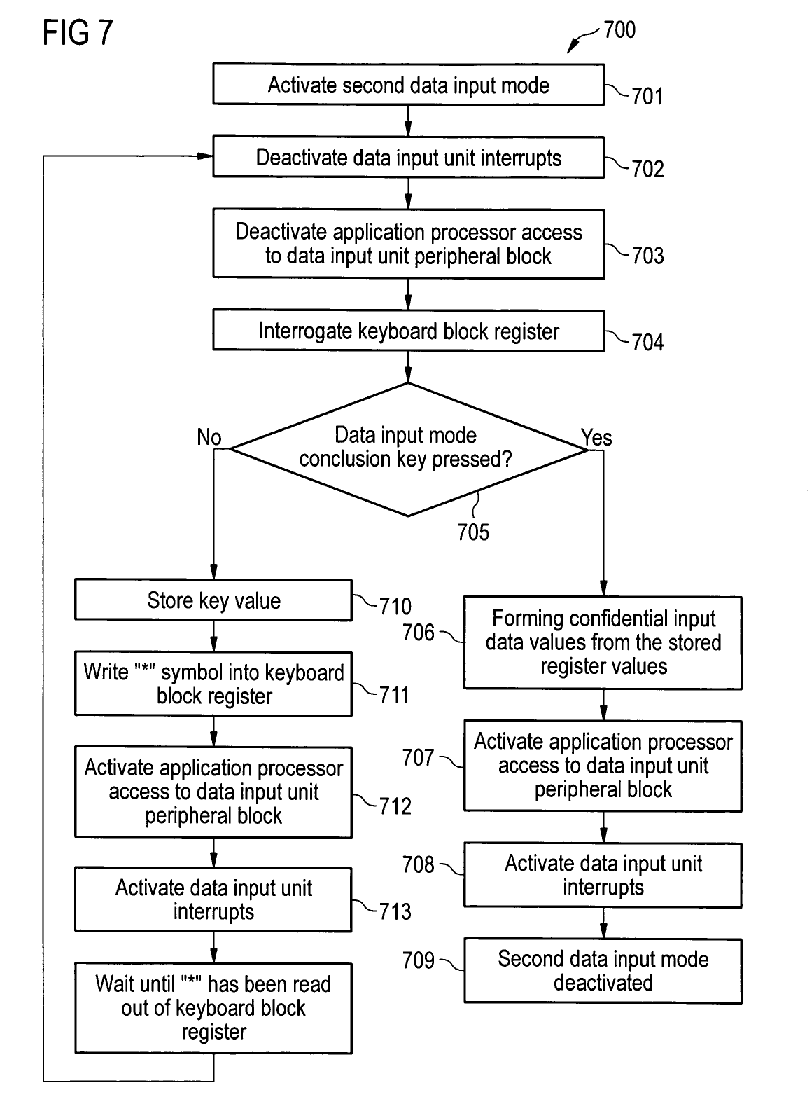

The implementation on the trusted core processor 102, shown above and in the text which follows in connection with FIG. 7, has the effect that from the point of view of the application processor 101, only a predetermined character is input in the second data input mode, i.e. a predetermined key is pressed, for example the key with the symbol “*”. The application processor 101 thus displays the “*” symbol received by it from the keyboard driver computer program on the data display unit. In this manner, an operating “look and feel” is achieved for the user during the input of a PIN code or of a password.

Whilst the data processing device 100 is in the second data input mode, it is optionally provided to provide a corresponding security mode indicating information item for the data display unit whereupon the data display unit outputs a corresponding data input mode indication 614 to the user. The different possibilities for representing the data input mode provided or activated in each case will be explained in further detail below.

FIG. 7 shows the procedure according to the second embodiment described above in a flowchart 700.

After activating the second data input mode (step 701), the trusted core processor 102 deactivates the performance or triggering of data input unit interrupts, particularly of keyboard interrupts at the application processor (702) and also deactivates (step 703) the access by the application processor 101 to the keyboard peripheral block 801 (compare FIG. 8) (generally to the data input unit peripheral block).

After that, the keyboard block registers, in which the information of the pressed keys is stored, are interrogated by the second processor, i.e. by the trusted core processor 102 (step 704).

If a secure data input mode conclusion key, preferably provided in the keyboard, is pressed, which is checked in a test step 705, it is assumed that the secure data input is ended and one or more confidential input data values are generated from the interrogated register values (step 706).

After that, the application processor 101 again obtains access to the keyboard peripheral block 801 (step 707) and the keyboard interrupts are also activated again for the application processor 101 (step 708).

The second data input mode is thus deactivated again (step 709).

However, as long as the secure data input mode conclusion key is not pressed, the value representing the key pressed in each case is stored for each pressed key in a memory only accessible to the trusted core processor 102 (step 710).

After that, an “*” symbol is written into the keyboard block registers for each symbol input (step 711) and the application processor 101 again obtains access to the keyboard peripheral block (step 712) and finally, the keyboard interrupts for the application processor 101 are released again (step 713). After that, the system waits until the application processor 101 has read the “*” symbol out of the keyboard peripheral block register (step 714) and continues in step 702. In other words, it is ensured that the application processor 101 has read the “*” symbol out of the keyboard peripheral block register.

As can be seen in FIG. 8, a scan and debounce logic 802 is provided in the modified keyboard peripheral block 801, and a switch unit 803 by means of which the symbols input are supplied from the scan and debounce logic 802 to a scan result register 804 according to a first switch position (A) of the switch unit 803, or, in a second switch position (B) of the switch unit 803, directly to the computer bus interface 805 which is additionally coupled to the output of the scan result register 804. The computer bus interface 805 is also coupled to a control register 806, the data stored in the control register 804 generating a switch state control signal 807, if necessary, and using it to drive the switch unit 803.

According to a third embodiment, it is provided that in the normal data input mode, the keyboard or the keypad directly transfers the information via the pressed key directly to the application processor 101.

After activation of the second data input mode (secure data input mode) and after the trusted core processor 102 has requested the input of the confidential data symbols, the keyboard peripheral driver device outputs, instead of the information about the pressed key, a predeterminable exchange data character/data symbol, for example the “*” symbol, which is displayed to the user, for example in the PIN input field on the graphical user interface of the data display unit 103.

When the digit keys are pressed by the user, this information is directly forwarded to the application processor 101 without exchange of the key information. The application processor 101 thus always obtains valid key information which it can display to the user on the graphical user interface, i.e. on the data display unit, and thus provide the user with an operating “look and feel”. The keys actually input are sequentially accumulated in a memory or a part of a memory, the memory or the part of the memory only being accessible from the trusted core processor 102.

The application processor 101 does not have access to this memory or this part of the memory. After the input of the confidential information has been completely concluded, the data sequence input is further processed by the trusted core processor 102 for validating it. Thus, the data sequence input is compared, for example, with a corresponding value stored on a smart card or in a flash memory.

According to this embodiment, it is not required to deactivate any interrupt in the application processor 101 during the inputting of the confidential data character/data symbol, preferably during the password input or during the PIN input. The interrupts should only be deactivated during the verification of the password by the trusted core processor 102. However, the verification of the password or of the PIN code can be performed in an additionally provided cryptographically protected block. In this manner, the password cannot be determined directly by the application processor 101 or, in other words, it does not have any access to the password which is stored in the cryptographic block.

The password cannot be determined by the application processor 101, in other words, it does not have any access to the password which is stored in the cryptographic block.

The keyboard driver or the keypad driver or its functionality can be implemented directly in hardware, i.e. by means of a special electronic circuit, by means of, for example, an FPGA or an ASIC or in a multi-processor environment in software, by means of a computer program or in any hybrid form, i.e. in any proportions in hardware and in software. If the driver functionality is implemented by means of a computer program, the computer program is executed on the trusted core processor 102 and the information about the pressed key or the exchange symbol for the pressed key, respectively, is transmitted to the application processor 101 by using the inter-processor communication (IPC).

In the text which follows, different variants for activating the second data input mode are described.

In a first variant, implicit activation of the second data input mode is provided. In the case of implicit activation of the second data input mode, no separate action by the user is required for changing the data processing device into the second data input mode. The software executed by the trusted core processor 102 activates the second data input mode independently as soon as a function is called up which contains a security service (as an alternative, the function can be the security service itself), within the context of which confidential information input by a user is processed. This can be done by the trusted core processor 102, for example by receiving a corresponding request message from the application processor 101 as has been explained in connection with the flow chart 500 in FIG. 5.

In an alternative embodiment, explicit activation of the second data input mode or its deactivation, respectively, by using a special data input mode change key provided for the purpose is provided. In this case, a data input mode change is effected by the user by pressing a special key, the key being exclusively under the control of the trusted core processor 102, i.e., in other words, the information representing the pressing of this special key can only be received and processed by the trusted core processor 102. In this case, the application computer program asks the user for an input of a password or of a PIN code by using a corresponding graphical user interface. After the request for inputting confidential data has been displayed, the user presses the special key and thus effects the change of the data processing device from the first data input mode to the second, secure data input mode and thus transfers control or possession of the keyboard, generally the data input unit, from the application processor 101 to the trusted core processor 102. As described above in connection with various embodiments, the trusted core processor 102 activates a corresponding data input mode indication, for example by using an additionally provided light-emitting diode or by means of a symbol which is displayed on the data display unit, and the user can then input the password into the data processing device in a secure environment.

In the text which follows, various possibilities and alternative embodiments for indicating the second data input mode, i.e. the secure data input mode for the data processing device, to the user are described.

According to a first implementation as described in EP 1 329 787 A2, the trusted core processor 102 utilizes a light-emitting diode specially provided for the purpose (or another, suitable output device) for indicating to the user that the second, secure data input mode is activated.

In this connection, it is desired that the data output device used in each case can only be driven and controlled by the trusted core processor 102 but not by the application processor 101. The indication of the secure data input mode is displayed to the user for as long as the second data input mode is activated.

According to an alternative embodiment, it is provided that a secure display or, as an alternative, a protected graphical user interface or a protected part of a graphical user interface is used for indicating the second data display mode of the data processing device.

This can be implemented in the following manner:
If, for example, a mobile radio telecommunication terminal is used, the user is requested to input a personal code (a digit sequence or a password) into the mobile radio telecommunication terminal.
The code input is stored in an external flash memory, preferably in encrypted form, and a flag is set in the external flash memory so that an initialization state is detected. This method for secure input of the confidential data is now initialized and ready for use. All this is done under the control of the trusted core processor 102.
As soon as the ready state is established, the identical method is performed as described above in connection with EP 1 329 787 A2, with the following difference:
When the user wishes to perform a protected transaction, the mobile radio telecommunication terminal indicates its secure data input mode by displaying the user's own personal code or the user's own password to the user on the data display unit instead of a light-emitting diode being activated.
The user can now perform his protected transaction.

According to yet another alternative embodiment, it is provided to use a trusted display for indicating the secure data input mode of the data processing device.

In this embodiment, a single data display unit is provided for indicating trusted application data and for indicating whether the secure data input mode is activated.

If the secure data input mode is activated, it is provided that only a predefinable programmable part area of the data display unit, preferably of a graphical user interface or the entire data display unit, preferably the entire graphical user interface, can only be controlled by the trusted core processor 102, i.e. can only be accessed by the latter. The application processor 101 does not have any rights of access to the content of the information indicated in the data display unit or the graphical user interface or in the part areas selected in each case. This prevents damaging computer program code installed on the application processor 101, for example a Trojan Horse computer program, from reading or manipulating the confidential information indicated on the data display unit or the graphical user interface. To prohibit the access of the application processor 101 to the relevant areas, it is provided to prevent computer program code executed on the application processor 101 from overwriting data in the data display unit or the corresponding protected part areas of the data display unit or the graphical user interface, for example with some type of input request to the user.

This can be implemented in the following manner:
If a mobile radio telecommunication terminal is used, the user is requested to input a personal code (for example a digit sequence or a password) into the mobile radio telecommunication terminal by means of the data input unit and additionally optionally to select a symbol representing a digital seal by means of which the second data input mode (trusted input mode) is indicated to the user. When performed, the requested input by the user is stored in an external flash memory, preferably in encrypted form, and a flag is set in the external memory by means of which the initialization status is indicated. The method is thus initialized for secure data input and ready to be used. All this is done under the control of the trusted core processor 102. The application processor 101 cannot access these data.
If the second data input mode is activated, the method is identical to the method described in EP 1 329 787 A2, with the following difference:
If the user wishes to perform a protected transaction, the trusted core processor 102 indicates its protected status by indicating the personal code of the user or the personal password of the user to the user or the symbol selected by the user and representing the digital seal, in the area of the data display unit which can only be activated by the trusted core processor 102, in other words which can only be accessed by the trusted core processor 102.

To indicate to the user the areas of the trusted area on the data display unit or the graphical user interface, respectively, the symbol or the personal code can be used as pattern for the boundary line of the trusted area or a correspondingly changed color or a correspondingly changed pattern of the background of the data display unit or the graphical user interface, respectively, can be provided in the protected area. In EP 1 056 014 A1, these indications are implemented, for example, by using a trusted image.

As an alternative, a cursor (masking) can be used. According to this embodiment, the image of the cursor can only be programmed or activated by the trusted core processor. The image depends on the position of the cursor within the data display unit or within the graphical user interface and on whether the position belongs to the trusted area or not. If the cursor is located in the trusted area, i.e. in the protected area, the cursor gets the look selected by the user for indicating the protected data input mode and if the cursor is outside the protected area, a preset cursor, by means of which the normal data input mode is indicated, is indicated to the user.

In the second data input mode, the completed input of data by means of the user is exclusively processed by the trusted core processor 102.

According to another embodiment, it is provided to display a pixel map, representing the trusted image, on the data display unit or to provide instructions to display the image to a user in each case differently depending on whether the data input by the user are input in an unprotected data input mode and thus supplied to the application processor 101 or whether the data are input in a protected data input mode and are only supplied to the trusted core processor 102.

If programmable graphical user interfaces (mask) are used which, depending on appearance, unambiguously represent a respective data input mode, it is possible to provide a protected and unprotected area for data specification within one data display unit.

The user can then perform his protected transaction by inputting the confidential data into the data processing device or he can be sure that he can trust the information represented on the screen, generally the data display unit.

What is claimed is:

1. A data processing device, comprising:
a data input unit for inputting data into the data processing device;
a first processor set up such that, in a first data input mode, it receives and processes the data input into the data input unit, the first processor having control over the data input unit in the first data input mode; and
a second processor set up such that, in a second, security-related data input mode, it receives and processes the data input into the data input unit, the second processor having control over the data input unit in the second data input mode.

2. The data processing device as claimed in claim 1, wherein the data input unit is selected from the group consisting of a keyboard, a data communication interface, a touchpad, a touch screen, a computer mouse, and a microphone.

3. The data processing device as claimed in claim 1, wherein the first processor is set up as an application processor for executing application computer programs.

4. The data processing device as claimed in claim 1, wherein an open operating system is executed by the first processor.

5. The data processing device as claimed in claim 4, wherein the open operating system comprises at least one communication interface external to the operating system.

6. The data processing device as claimed in claim 4, wherein the open operating system is selected from the group consisting of a Windows operating system, a Linux operating system, a Unix operating system, a Symbian operating system, and a Java platform.

7. The data processing device as claimed in claim 1, wherein the second processor is set up such that it can only execute one or more trusted computer programs.

8. The data processing device as claimed in claim 7, wherein a trusted computer program is an integrity-protected computer program.

9. The data processing device as claimed in claim 8, wherein an integrity-protected computer program is a cryptographically integrity-protected computer program.

10. The data processing device as claimed in claim 7, wherein a trusted computer program is set up for providing at least one security-related service.

11. The data processing device as claimed in claim 10, wherein the security-related service is a cryptographic security service.

12. The data processing device as claimed in claim 11, wherein the cryptographic security service is provided by using at least one cryptographic key.

13. The data processing device as claimed in claim 12, wherein the cryptographic security service is provided by using at least one private cryptographic key and/or at least one public cryptographic key.

14. The data processing device as claimed in claim 11, wherein the cryptographic security service is at least one of a security service selected from the group consisting of a digital signature, a digital seal, authentication, an encryption of data, an admission control, access control, prevention of traffic analyses during a data communication, and a hash process.

15. The data processing device as claimed in claim 1, comprising a data display unit for indicating at least a part of the data input.

16. The data processing device as claimed in claim 15, set up such that in the second data input mode, the second processor receives the data input and transmits data, which are different from the data input, to the first processor and/or the data display unit.

17. The data processing device as claimed in claim 16, wherein the data transmitted by the second processor has the same number of data symbols as the data input.

18. The data processing device as claimed in claim 16, set up such that data transmitted from the second processor to the first processor and/or the data display unit are a sequence of predetermined data symbols, the number of data symbols being identical to the number of data symbols of the data input.

19. The data processing device as claimed in claim 15, wherein the second processor is set up such that it transmits a security mode indicating information item to the first processor and/or the data display unit in the second data input mode.

20. The data processing device as claimed in claim 19, wherein the security mode indicating information is visual information and/or audio information.

21. The data processing device as claimed in claim 1, further comprising an inter-process communication unit for performing communication between the first processor and the second processor during a transfer of control of the data input unit from the first processor to the second processor or from the second processor to the first processor.

22. The data processing device as claimed in claim 1, further comprising a data input unit driver unit which is set up such that the data input in the first data input mode are transmitted to the first processor, and the data input in the second data input mode are transmitted to the second processor.

23. The data processing device as claimed in claim 22, wherein the data input unit driver unit is set up such that data, which are different from the data input in the second data input mode, are transmitted to the first processor and/or the data display unit.

24. The data processing device as claimed in claim 22, wherein the data input unit driver unit is set up such that data, which are different from the data input in the second data input mode, are transmitted with the same number of data symbols to the first processor and/or the data display unit.

25. The data processing device as claimed in claim 23, wherein the data transmitted to the first processor and/or the data display unit are a sequence of predetermined data symbols, the number of data symbols being equal to the number of data symbols of the data input.

26. The data processing device as claimed in claim 1, wherein the second processor is set up as a digital signal processing processor.

27. The data processing device as claimed in claim 1, wherein the second processor is set up as a chip card processor.

28. The data processing device as claimed in claim 1, wherein the second processor is integrated in a subscriber identification module of a telecommunication terminal.

29. A telecommunication terminal comprising a data processing device as claimed in claim 1.

30. A method for data processing by means of a data processing device, comprising the steps of:
inputting data into the data processing device by means of a data input unit;
receiving and processing by a first processor in a first data input mode, data input into the data input unit, the first processor having control over the data input unit in the first data input mode; and
receiving and processing by a second processor in a second, security-related data input mode, data input into the data input unit, the second processor having control over the data input unit in the second data input mode.

31. A data processing device, comprising:
a data input means for inputting data into the data processing device;
a first processing means for, in a first data input mode, receiving and processing the data input into the data input means, the first processing means having control over the data input means in the first data input mode; and
a second processing means for, in a second, security-related data input mode, receiving and processing the data input into the data input means, the second processing means having control over the data input means in the second data input mode.
